(19) United States
(12) Patent Application Publication
(10) Pub. No.: US 2018/0040962 A1
(43) Pub. Date: Feb. 8, 2018

(54) RADIO-FREQUENCY REFLECTOR INCORPORATING A REFLECTION APODIZATION ELEMENT

(71) Applicant: Keysight Technologies, Inc., Minneapolis, MN (US)

(72) Inventor: Gregory Steven Lee, Mountain View, CA (US)

(21) Appl. No.: 15/230,083

(22) Filed: Aug. 5, 2016

(51) Int. Cl. H01Q 15/14; H01Q 1/36; H01Q 1/24

(52) U.S. Cl. CPC H01Q 15/14; H01Q 1/241; H01Q 1/36

(57) ABSTRACT

Various illustrative embodiments disclosed herein generally pertain to an RF reflector incorporating a number of reflection apodization elements, each of which is mounted upon a signal reflecting surface of the RF reflector with an inner edge in substantial contact with an inner portion of the signal reflecting surface and an outer edge elevated above a peripheral portion of the signal reflecting surface. The outer edge is elevated to a height corresponding to a quarter-wavelength of a predefined wavelength. This arrangement bestows a gradually variant reflectance characteristic to the RF reflector, with the inner edge of each reflection apodization element providing substantially the same amount of reflectance as the signal reflecting surface of the RF reflector and the outer edge providing substantially no reflectance at the peripheral portion of the signal reflecting surface. Intermediate portions of the reflection apodization element provide various levels of reflectance with no abrupt changes or discontinuities.

### BACKGROUND

Communication systems sometimes employ a radio-frequency reflector to reflect a microwave/millimeter-wave beam. Often, the size of the microwave/millimeter-wave beam that is directed at the reflector extends beyond the reflector surface due to a variety of reasons. For example, in some cases it may be impractical to deploy a microwave/millimeter-wave feed horn having transmission features that are precisely tailored to limit the size of the beam within the reflector surface, while in some other cases the dimensions and/or weight characteristics of a larger reflector that matches a particular beam size may make the use of the larger reflector unsuitable and/or cost-prohibitive.

Thus, as a result of a size mismatch that can be present between a traditional reflector and a microwave/millimeter-wave beam, the fraction of the microwave/millimeter-wave beam that is reflected by the traditional reflector can have a spatially hard-clipped characteristic incorporating distortion in the form of undesirable angular plane-wave components. The undesirable angular plane-wave components contain propagation vectors (“k-vectors”) that differ significantly from a main k-vector of the reflected microwave/millimeter-wave beam.

### SUMMARY

Certain embodiments of the disclosure can provide a technical effect and/or solution to avoid radio-frequency reflections at a periphery of a radio-frequency reflector by incorporating an array of reflection apodization elements mounted upon a signal reflecting surface of the radio-frequency reflector with an inner edge of each reflection apodization element in substantial contact with the signal reflecting surface at an inner portion of the signal reflecting surface and an outer edge of each reflection apodization element elevated above a peripheral portion of the signal reflecting surface to a height corresponding to a quarter-wavelength of a predefined wavelength.

According to one exemplary embodiment of the disclosure, a radio-frequency reflector includes a signal reflecting surface and a reflection apodization element. The signal reflecting surface is configured to reflect at least a first radio-frequency signal of a predefined wavelength. The reflection apodization element has an intrinsic impedance that matches a characteristic impedance of free-space and is mounted upon the signal reflecting surface with an inner edge of the reflection apodization element arranged in substantial contact with the signal reflecting surface at an inner portion of the signal reflecting surface and an outer edge of the reflection apodization element elevated above a peripheral portion of the signal reflecting surface to a height corresponding to a quarter-wavelength of the predefined wavelength.

According to another exemplary embodiment of the disclosure, a method of making a radio-frequency reflector can include various operations such as providing a planar resistive sheet having a sheet impedance (Zₛₕₑₑₜ) that is less than a characteristic impedance (Z₀) of free-space, and transforming the planar resistive sheet into a reflection apodization element having a mesh structure, the mesh structure providing an effective intrinsic impedance equal to the characteristic impedance (Z₀) of free-space. The transforming can include defining a mesh stripe width (w) to pitch (p) ratio that is substantially equal to Zₛₕₑₑₜ/Z₀ and fabricating the mesh structure into the planar resistive sheet using the selected mesh stripe width (w) to pitch (p) ratio.

According to yet another exemplary embodiment of the disclosure, a method of using a radio-frequency reflector can include various operations such as using a central portion of a signal reflecting surface of the radio-frequency reflector to provide a uniform level of reflectance to a first portion of a radio-frequency signal of a predefined wavelength, and using a reflection apodization element of the radio-frequency reflector to provide an apodized reflectance to a second portion of the radio-frequency signal of the predefined wavelength, the apodized reflectance characterized at least in part by a substantially zero reflectance at a periphery portion of the signal reflecting surface.

Other embodiments and aspects of the disclosure will become apparent from the following description taken in conjunction with the following drawings.

### BRIEF DESCRIPTION OF THE FIGURES

Many aspects of the invention can be better understood by referring to the following description in conjunction with the accompanying claims and figures. Like numerals indicate like structural elements and features in the various figures. For clarity, not every element may be labeled with numerals in every figure. The drawings are not necessarily drawn to scale; emphasis instead being placed upon illustrating the principles of the invention. The drawings should not be interpreted as limiting the scope of the invention to the example embodiments shown herein.

FIG. 1 shows an exemplary embodiment of a radio-frequency reflector incorporating an array of reflection apodization elements in accordance with the disclosure.

FIG. 2 shows a cross-sectional view of one of the reflection apodization elements shown in FIG. 1.

FIG. 3 shows a graph illustrating reflectance versus normalized height values associated with a reflection apodization element mounted on a radio-frequency reflector in accordance with the disclosure.

FIG. 4 shows a graph illustrating relative reflectance phase versus normalized height values associated with a reflection apodization element mounted on a radio-frequency reflector in accordance with the disclosure.

FIG. 5 shows a cross-sectional view of an example reflection apodization element when implemented in accordance with a second exemplary configuration.

FIG. 6 shows an exemplary embodiment of a reflection apodization element that is fabricated from a planar resistive sheet in accordance with the disclosure.

FIG. 7 shows a flowchart illustrating some exemplary steps for fabricating the reflection apodization element shown in FIG. 6.

FIG. 8 shows another exemplary embodiment of a radio-frequency reflector incorporating an array of reflection apodization elements in accordance with the disclosure.

FIG. 9 shows a cross-sectional view of one of the reflection apodization elements shown in FIG. 8.

FIG. 10 shows a cross-sectional view of another one of the reflection apodization elements shown in FIG. 8.

### DETAILED DESCRIPTION

Throughout this description, embodiments and variations are described for the purpose of illustrating uses and implementations of inventive concepts. The illustrative description should be understood as presenting examples of inventive concepts, rather than as limiting the scope of the concepts as disclosed herein. Towards this end, certain words and terms are used herein solely for convenience and such words and terms should be broadly understood as encompassing various objects and actions that are generally understood in various forms and equivalencies by persons of ordinary skill in the art. For example, words such as “standoff” and “abutment member” as used herein can generally indicate various mechanical elements such as a screw, a rod, a shaft, a stem, or a pin, and can be used for various purposes such as anchoring, blocking, or elevating a reflection apodization element mounted upon a reflecting surface of a radio-frequency reflector in accordance with the disclosure. It should also be understood that the word “example” as used herein is intended to be non-exclusionary and non-limiting in nature. More particularly, the word “exemplary” as used herein indicates one among several examples and it should be understood that no special emphasis, exclusivity, or preference, is associated or implied by the use of this word.

It should be further understood that the phrase “reflection apodization element” as used herein generally refers to a structural element having one of an intrinsic impedance that matches a characteristic impedance of free-space (approximately 377 ohms) or a structural element that is fabricated to provide an effective intrinsic impedance matching the characteristic impedance of free-space. One example of a structural element having an intrinsic impedance that matches a characteristic impedance of free-space is a resistive sheet having an impedance of 377 Ω/square. In some embodiments in accordance with the disclosure, an effective intrinsic impedance of 377 Ω/square can be achieved by modifying an element having a different intrinsic impedance. For example, a resistive sheet having an intrinsic impedance of less than 377 Ω/square can be modified to incorporate a mesh structure that increases the intrinsic impedance of the unmodified resistive sheet and transforms the resistive sheet into a reflection apodization element having an effective intrinsic impedance of 377 Ω/square.

In terms of an overview, the various illustrative embodiments disclosed herein generally pertain to a radio-frequency (RF) reflector incorporating a number of reflection apodization elements. Each of the reflection apodization elements is mounted upon a signal reflecting surface of the RF reflector with an inner edge in substantial contact with an inner portion of the signal reflecting surface and an outer edge elevated above a peripheral portion of the signal reflecting surface. More particularly, the outer edge is elevated to a height corresponding to a quarter-wavelength of a predefined wavelength. This arrangement bestows a gradually variant reflectance characteristic to the RF reflector, with the inner edge of each reflection apodization element providing substantially the same amount of reflectance as the signal reflecting surface of the RF reflector and the outer edge providing substantially no reflectance at the peripheral portion of the signal reflecting surface. Furthermore, when mounted upon the signal reflecting surface, the intermediate portions of the reflection apodization element bestow upon the RF reflector, various levels of reflectance with no abrupt changes or discontinuities. Significantly, the elimination of reflectance at the peripheral portion of the signal reflecting surface prevents the occurrence of undesirable angular plane-wave components and other distortions at the periphery of the RF reflector.

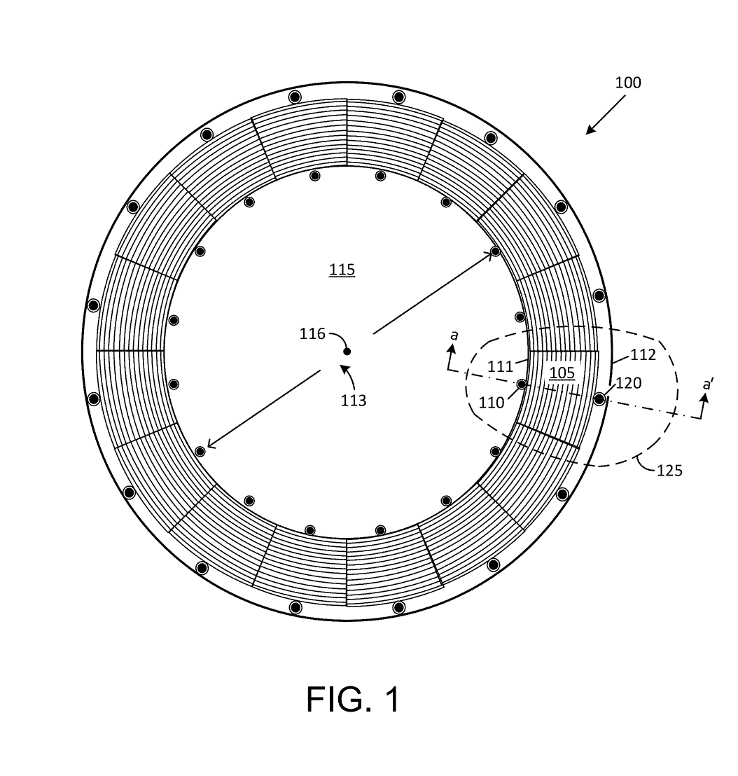

Attention is now drawn to FIG. 1, which shows an exemplary embodiment of an RF reflector 100 in accordance with the disclosure. In this exemplary embodiment, RF reflector 100 includes a number of reflection apodization elements mounted in an annular configuration upon a circular signal reflecting surface 115. All the reflection apodization elements are substantially similar to each other. Consequently, solely for purposes of description, one exemplary reflection apodization element 125 will be used hereafter and as such, the characteristics, structural features, and operational features of each of the other reflection apodization elements can be understood accordingly. It should be understood however, that in other embodiments, two or more reflection apodization elements can be arranged in configurations other than an annular configuration, and/or the signal reflecting surface 115 can have a non-circular shape (such as a rectangular shape that is described below in another exemplary embodiment).

The signal reflecting surface 115 is configured to provide a uniform level of reflectance to an RF signal of a predefined wavelength. Towards this end, the signal reflecting surface 115 can incorporate a planar signal reflecting portion, a curved signal reflecting portion, or a combination of several portions having various shapes and contours. In some applications, the predefined wavelength can be a predefined microwave/millimeter wavelength and the signal reflecting surface 115 is dimensioned and shaped to provide a designated level of reflectance to this predefined microwave/millimeter wavelength. In other applications, the RF signal can be a broadband signal, such as a multiplexed RF signal or a modulated RF signal, and the signal reflecting surface 115 is dimensioned and shaped to provide a designated level of reflectance to a central wavelength among the multiple wavelengths present in the broadband signal. In the case of the broadband signal, the central wavelength can be designated as the predefined wavelength that is reflected by the signal reflecting surface 115 in accordance with the disclosure.

As indicated above, the signal reflecting surface 115 has a circular shape in this exemplary embodiment and the reflection apodization elements are mounted in an annular configuration upon the signal reflecting surface 115. The shading provided on the reflection apodization element 125 (as well as on all other reflection apodization elements) is indicative of a sloping reflecting segment 105 that linearly extends downwards and radially inwards from a periphery 114 of the signal reflecting surface 115. More particularly, an outer edge 112 of the reflection apodization element 125 is elevated above a peripheral portion of the signal reflecting surface 115 (area near the periphery 114) to a height corresponding to a quarter-wavelength of the predefined wavelength. An inner edge 111 of the reflection apodization element 125 is arranged in substantial contact with the signal reflecting surface 115 at an inner portion of the signal reflecting surface 115.

The inner portion of the signal reflecting surface 115, which can also be referred to herein as a central portion, encompasses a circular area that surrounds a central point 116. The circular area can extend up to a maximum extent indicated by a diametric distance 113. In other embodiments where the signal reflecting surface 115 is non-circular in shape, the inner portion of the signal reflecting surface 115 can be defined on the basis of a desired placement and pattern of two or more reflection apodization elements.

The outer edge 112 of the reflection apodization element 125 is elevated above the signal reflecting surface 115 to a height corresponding to a quarter-wavelength of the predefined wavelength by using suitable mounting hardware such as a standoff member 120 that can include one or more anchoring elements such as a screw or a fastener. The inner edge 111 of the reflection apodization element 125 that is arranged in substantial contact with the signal reflecting surface 115 is anchored and prevented from moving towards a central portion of the signal reflecting surface 115 by using mounting hardware such as an abutment member 110. The abutment member 110 is attached to the signal reflecting surface 115 so as to abut the inner edge 111 of the reflection apodization element 125, thereby preventing a lateral shift of the inner edge 111 towards the central portion of the signal reflecting surface 115.

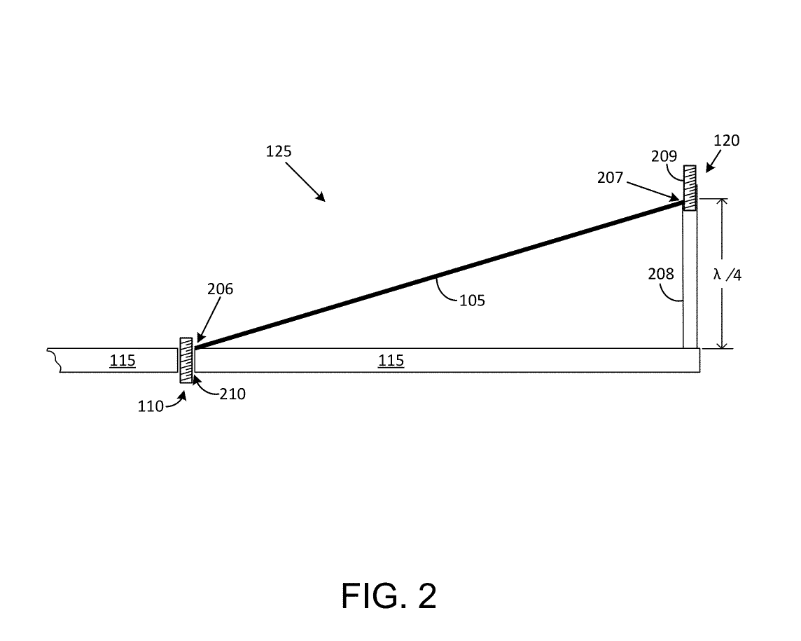

FIG. 2 shows a cross-sectional view of the reflection apodization element 125 when the reflection apodization element 125 is implemented in accordance with a first exemplary configuration. The orientation of the cross-sectional view is indicated in FIG. 1 by a dashed line representation (a-a′). In this first exemplary configuration, the abutment member 110 can be a dowel, a pin, a post, or a screw that is inserted through a hole 210 in the signal reflecting surface 115. The dimensions of the abutment member 110 (such as a diameter of the abutment member 110) can be selected on the basis of providing mechanical integrity while minimizing adverse impacts upon the reflectance of the signal reflecting surface 115.

The standoff member 120 can include two or more elements such as a post 208 and an abutment member 209. The abutment member 209, which can be similar or identical to the abutment member 110 in terms of structure, is positioned to abut the outer edge 112 of the reflection apodization element 125, thereby preventing an outwards lateral shift of the outer edge 112. In one exemplary implementation, the abutment member 209 is inserted into the post 208 in a manner that allows for an exposed top surface of the post 208. The exposed top surface of the post can operate as a platform for the outer edge 112 of the reflection apodization element 125. The height of the post 208 is selected to correspond to a quarter-wave length (λ/4) of the predefined wavelength that is predefined for reflection by the signal reflecting surface 115. As a result of height of the post 208, the outer edge 112 of the reflection apodization element 125 is elevated above the signal reflecting surface 115 by the quarter-wavelength.

In some applications, a height adjustable element, such as a threaded post, can be used to implement the post 208. The threaded post can include multiple components such as a threaded shank that is inserted into a threaded socket. The threaded shank can be adjustable so as to vary the height of the post 208. When implemented in height adjustable form, the post 208 can be adjustably set to cater to various quarter-wavelength heights corresponding to various predefined wavelengths reflected by the signal reflecting surface 115 thereby allowing the RF reflector 100 to be used for a number of different applications involving various wavelengths. Correspondingly, in some cases, particularly at lower wavelengths, the hole 210 can be a slotted opening that is used to adjust a radial distance placement of the abutment member 110 with respect to the periphery 114 of the circular signal reflecting surface 115, in order to accommodate various quarter-wavelength heights.

The sloping reflecting segment 105 that extends downwards and inwards from the standoff member 120 to the signal reflecting surface 115 provides a gradually variant reflectance characteristic to the reflection apodization element 125. Specifically, at a first location 206 where the sloping reflecting segment 105 is substantially flush with the signal reflecting surface 115, the reflection apodization element 125 provides the same, or roughly the same, amount of reflectance as the signal reflecting surface 115. On the other hand, at a second location 207 that is elevated to a quarter-wavelength above the top reflecting portion of the signal reflecting surface 115, the reflection apodization element 125 provides substantially zero reflectance to the predefined wavelength. The zero reflectance can be attributed to a parallel combination of the intrinsic impedance (or effective intrinsic impedance) of the reflection apodization element 125 that matches free-space characteristic impedance, and an open-circuit quarter-wave length transformation of the signal reflecting surface 115 in accordance with transmission line theory associated with quarter-wavelength spacing. Intermediate portions of the sloping reflecting segment 105 operate in conjunction with the signal reflecting surface 115 to bestow upon the RF reflector 100, a gradually variant reflectance characteristic with no abrupt changes or discontinuities that adversely affect the predefined wavelength. The gradually variant reflectance characteristic can be characterized in part by a reactance “X” that the reflection apodization element 125 presents in conjunction with the signal reflecting surface 115 at various heights “t” along the intermediate portions of the sloping reflecting segment 105.

Specifically, the sloping reflecting segment 105 provides a gradually variant reflectance characteristic that ranges from a short-circuit operating condition (at the first location 206) to an open-circuit operating condition (at the second location 207), and can be quantified by using some equations that are shown below.

X=377 tan(2πt/λ) ohms/square Eqn. 1

where “t” is the height of the sloping reflecting segment 105 at any given point above the signal reflecting surface 115, λ is the wavelength, and “X” represents the reactance.

Thus in accordance with rules for combining parallel impedances, the load impedance (per square) at any particular intermediate portion of the sloping reflecting segment 105 of the reflection apodization element 125 can be determined as follows:

Z_{load}=j*377 tan(2πt/λ)/(1+j*tan(2πt/λ)) ohms/square Eqn.2

It can be understood that Z_{load}=0 (short circuit) at t=0 (i.e., at the first location 206) and Z_{load}=377 Ω/square (open circuit) at t=λ/4 (i.e., at the second location 207).

A complex reflection coefficient ρ of the electric field associated with the sloping reflecting segment 105 of the reflection apodization element 125 can be determined as follows:

ρ=(Z_{load}−377)/(Z_{load}+377) or ρ=−1/(1+j*2 tan(2πt/λ)) Eqn. 3

A power reflectance R=|ρ|² of the resistive mesh can be determined as follows:

R=1/(1+4 tan²(2πt/λ)) Eqn. 4

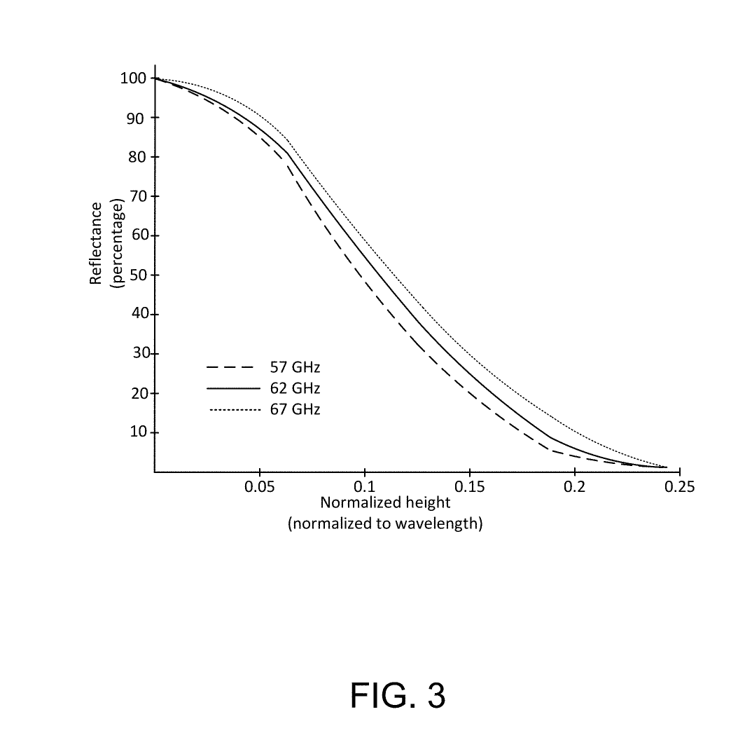

Attention is now drawn to FIG. 3, which shows a graph illustrating a relationship between percentage reflectance and normalized height values for a nominal 62 GHz wavelength, which is pertinent to the exemplary embodiment shown in FIG. 1, and two neighboring wavelengths (57 GHz and 67 GHz) straddling the nominal 62 GHz wavelength. Each of the three relationships shown in the graph has a substantially raised-cosine reflectance characteristic as a result of mounting the sloping reflecting segment 105 upon the circular signal reflecting surface 115 in the manner shown in FIG. 2. Attention is particularly drawn to the reflectance value of 100% that corresponds to a zero normalized height value and is applicable to the location 206 shown in FIG. 2 where the sloping reflecting segment 105 of the reflection apodization element 125 is substantially flush with the signal reflecting surface 115. Attention is further drawn to the reflectance value of zero that corresponds to a 0.25 normalized height value (λ/4), which is applicable to the location 207 shown in FIG. 2 where the sloping reflecting segment 105 of the reflection apodization element 125 is elevated a quarter-wavelength above the signal reflecting surface 115.

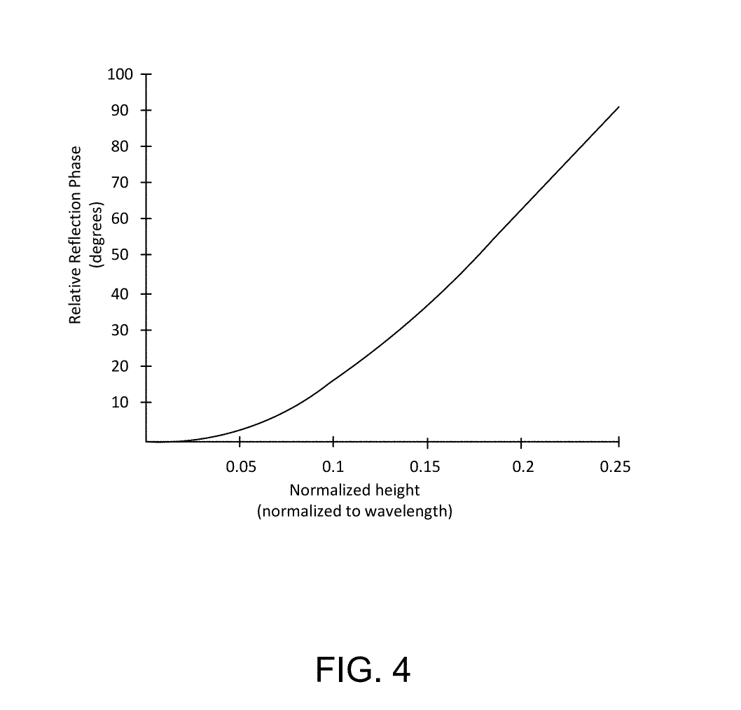

FIG. 4 shows a graph illustrating a relationship between relative reflection phase and normalized height values associated with the reflection apodization element 125 shown in FIG. 2. Specifically, the phrase “relative reflection phase” refers to a phase of a reflected wavelength at any given height along the sloping reflecting segment 105 when the reflection apodization element 125 is mounted upon the signal reflecting surface 115 versus a phase of the same wavelength when reflected by the signal reflecting surface 115 without the reflection apodization element 125 mounted upon it. The zero relative reflection phase corresponds to the location 206 (and also to the signal reflecting surface 115, because the sloping reflecting segment 105 is substantially at the same level as the signal reflecting surface 115). On the other hand, the 90° relative reflection phase (λ/2) corresponds to the location 207 that is located at a quarter-wavelength (λ/4) above the signal reflecting surface 115.

The relative reflection phase relationship shown in FIG. 4 provides certain advantages in terms of reflection apodization because the relative reflection phase departs gradually from the zero relative reflection phase where the reflectance provided by the resistive sheet is relatively very strong to a high relative reflection phase where the reflectance provided by the resistive sheet is relatively weak, without abrupt transitions in between.

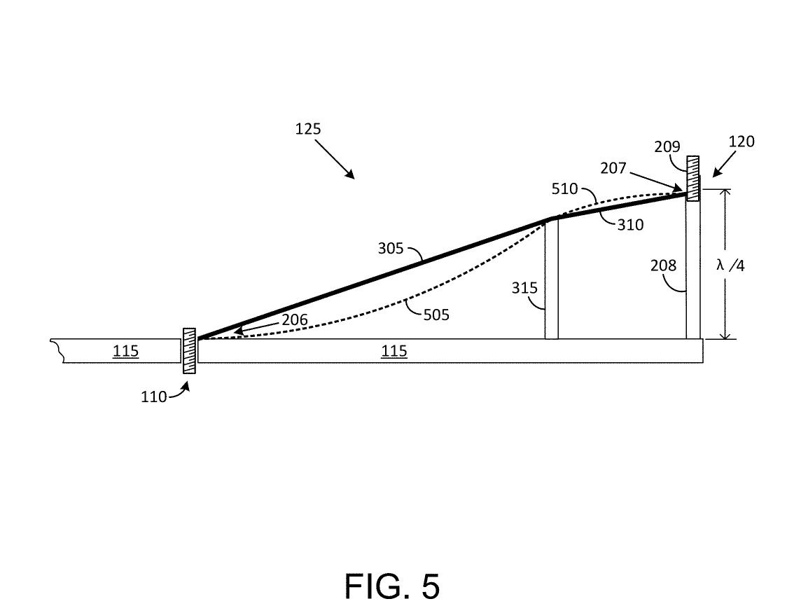

FIG. 5 shows a cross-sectional view of the reflection apodization element 125 when the reflection apodization element 125 is implemented in accordance with a second exemplary configuration. In contrast to the first exemplary configuration shown in FIG. 2 where the reflection apodization element 125 has a single linearly sloping reflecting segment 105, in this second exemplary configuration, the reflection apodization element 125 includes a first linearly sloping reflecting segment 305 as well as a second linearly sloping reflecting segment 310. An intermediate post 315 can be used to create a transition portion and/or to support the transition portion, where the first linearly sloping reflecting segment 305 transitions into the second linearly sloping reflecting segment 310. The intermediate post 315 can be implemented as a fixed height post or in a height-adjustable form (in the same manner as described above with respect to the post 208).

In an alternative implementation, the first linearly sloping reflecting segment 305 and/or the second linearly sloping reflecting segment 310 can have a non-linear shape as indicated in FIG. 5 using a dashed line format. Attention is particularly drawn to the location 206 where the non-linearly sloping reflecting segment 505 transitions towards a zero slope when merging into the signal reflecting surface 115, and also to the location 207 where the non-linearly sloping reflecting segment 510 transitions into a relatively flat portion having a λ/4 elevation.

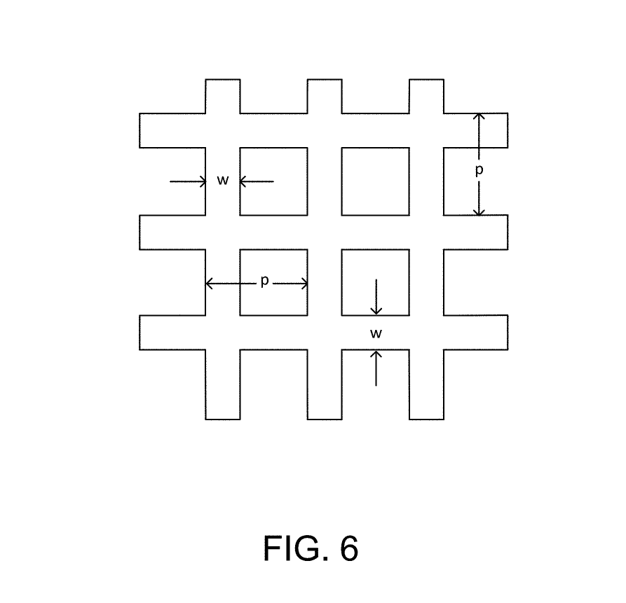

FIG. 6 shows an exemplary embodiment of a reflection apodization element 600 that is fabricated from a planar resistive sheet in accordance with the disclosure. The planar resistive sheet can include one or more resistive materials such as graphite, graphene, molybdenum sulfide (MoS2), doped silicon, doped amorphous silicon, and various alloys. A few examples of alloys include nichrome, titanium nitride (TiN), tungsten silicon nitride (WSiN), and phosphorus-doped nickel (Ni:P).

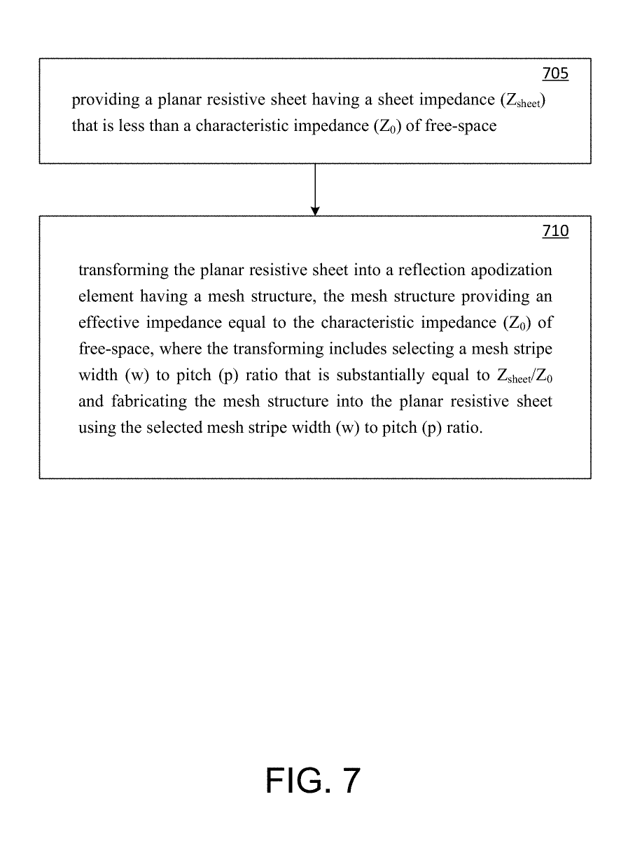

FIG. 7 shows a flowchart illustrating some exemplary steps for fabricating the reflection apodization element 600 shown in FIG. 6. As indicated in block 705 of the flowchart, a planar resistive sheet having an intrinsic sheet impedance (Zₛₕₑₑₜ) that is less than the characteristic impedance of free-space (Z₀) is provided. The intrinsic sheet impedance can encompass a range from about 10 Ω/square to about 150 Ω/square. The planar resistive sheet can be transformed into a reflection apodization element having an effective intrinsic impedance of 377 Ω/square by incorporating a mesh structure that increases the intrinsic sheet impedance to an effective intrinsic impedance of 377 Ω/square. This procedure can be executed (as indicated in block 710) by defining a mesh stripe width (w) to pitch (p) ratio that is substantially equal to Zₛₕₑₑₜ/Z₀ (i.e., w/p=Zₛₕₑₑₜ/377). In one exemplary implementation, a reflection apodization element having such a mesh structure can be fabricated by using a w/p ratio of about 0.54.

Fabricating of the mesh structure can be carried out by using various manufacturing techniques, such as chemical etching, micro-machining, laser cutting etc. Furthermore, in some example implementations, prior to fabrication of the mesh structure, a material of the planar resistive sheet can be deposited upon a thin substrate (such as a kapton substrate or a mylar substrate) and/or bonded to the substrate, so as to permit the resulting planar resistive sheet to be handled, bent, or flexed in various ways without suffering damage during fabrication of the mesh structure. Specifically, when the material of the planar resistive sheet is amorphous silicon, titanium nitride (TiN), and/or tungsten silicon nitride (WSiN), for example, this material can be deposited upon a suitable substrate such as the kapton substrate or the mylar substrate prior to fabrication of the mesh structure. When the material of the planar resistive sheet is graphene or a resistive alloy such as NiCrAlSi or phosphorus-doped nickel (Ni:P), for example, this material can be bonded to the kapton or mylar substrate. In some instances, the resistive alloy can be previously deposited upon a copper sheet and the copper sheet can be bonded to the kapton or mylar substrate, followed by removal of the copper via etching.

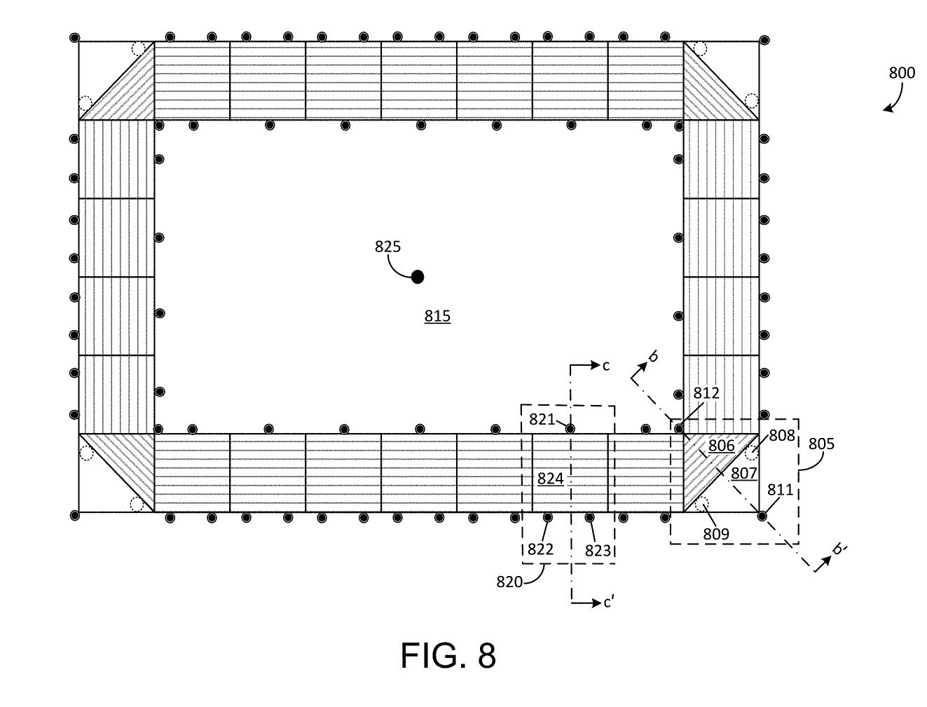

FIG. 8 shows another exemplary embodiment of an RF reflector 800 incorporating an array of reflection apodization elements in accordance with the disclosure. In contrast to the RF reflector 100 (shown in FIG. 1) that has a circular periphery, the RF reflector 800 has a quadrilateral-shaped periphery (in this example, a rectangular periphery) and includes two types of reflection apodization elements. Specifically, the two types of reflection apodization elements include a first reflection apodization element located at each of the four corners of the RF reflector 800 and a second reflection apodization element located along each of the four sides of the RF reflector 800. Solely for purposes of description, an exemplary first reflection apodization element 805 and an exemplary second reflection apodization element 820 will be used hereafter and as such the characteristics, structural features, and operational features of each of the other similar reflection apodization elements can be understood accordingly.

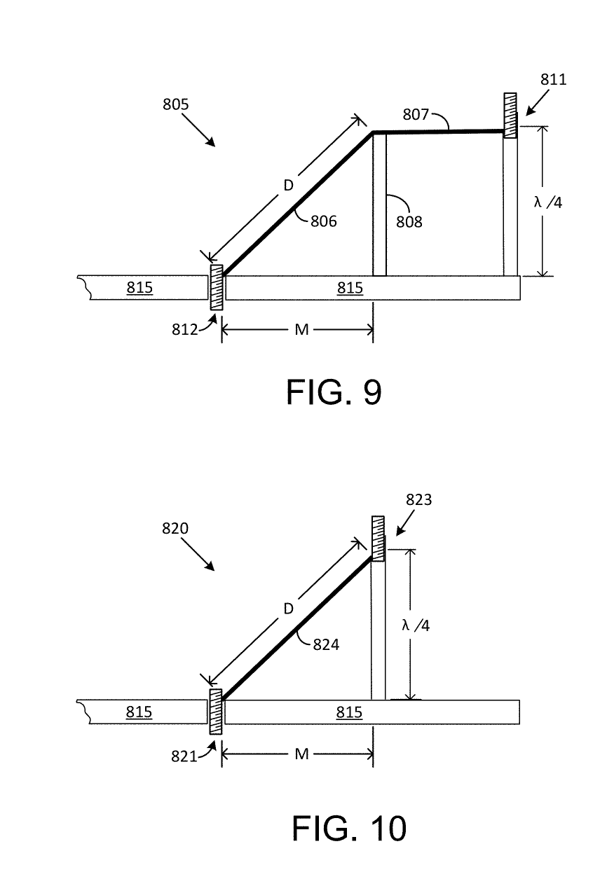

Attention is now drawn to FIG. 9, which shows a cross-sectional view of the first reflection apodization element 805. The orientation of the cross-sectional view is indicated in FIG. 8 by a dashed line representation (b-b′). An abutment member 812 that can be similar to the abutment member 110 shown in FIG. 1, can be used to prevent a lateral shift of one corner of a downwards sloping reflecting segment 806 of the first reflection apodization element 805, towards a central portion that surrounds the central point 816 upon the signal reflecting surface 815. In this embodiment, the central portion can be broadly defined as a rectangular area that surrounds a central point 825 of the rectangular periphery. A length dimension of the first sloping reflecting segment 806 is indicated as “D” and a distance between the abutment member 812 and an intermediate post 808 is indicated as “M.” The intermediate post 808 (which can be similar to the intermediate post 315 shown in FIG. 3) is used for elevating another corner of the first sloping reflecting segment 806 to a λ/4 height above the signal reflecting surface 815.

The first reflection apodization element 805 further includes a horizontal reflecting segment 807 that can be omitted in some example implementations. The horizontal reflecting segment 807 is elevated λ/4 above the signal reflecting surface 815 and thereby provides substantially zero reflectance to a predefined wavelength directed at the RF reflector 800. The intermediate post 808 and a standoff element 811 (which can be similar to the standoff element 120 shown in FIG. 1) are used in conjunction with another intermediate post 809 (shown in FIG. 8) to provide support for elevating the horizontal reflecting segment 807 above the signal reflecting surface 815.

FIG. 10 shows a cross-sectional view of the second reflection apodization element 820. The orientation of this cross-sectional view is indicated in FIG. 8 by a dashed line representation (c-c′). An abutment member 821 that can be similar to the abutment member 110 shown in FIG. 1, can be used to prevent a lateral shift of an inner edge of a sloping reflecting segment 824 towards the central portion that surrounds the central point 816. The length dimension (“D”) of the sloping reflecting segment 824 is the same as that of the downwards sloping reflecting segment 806 of the first reflection apodization element 805 shown in FIG. 9. The distance (“M”) between the abutment member 821 and a standoff element 823 is the same as the distance “M” between the abutment member 812 and the intermediate post 808 shown in FIG. 9. The standoff element 823 (which can be similar to the standoff element 120 shown in FIG. 1) is used in conjunction with another standoff element 822 (shown in FIG. 8) for elevating an outer edge of the sloping reflecting segment 824 to a λ/4 height above the signal reflecting surface 815.

In summary, it should be noted that the invention has been described with reference to a few illustrative embodiments for the purpose of demonstrating the principles and concepts of the invention. It will be understood by persons of skill in the art, in view of the description provided herein, that the invention is not limited to these illustrative embodiments. Persons of skill in the art will understand that many such variations can be made to the illustrative embodiments without deviating from the scope of the invention. Specifically, it will be understood that an RF reflector in accordance with the disclosure can be provided in various shapes other than the exemplary circular RF reflector and the rectangular RF reflector described herein. For example, an RF reflector in accordance with the disclosure can be provided in the shape of a paraboloid, an ellipsoid, a square, and/or an oval.

What is claimed is:

1. A radio-frequency reflector comprising:
a signal reflecting surface configured to reflect at least one radio-frequency signal of a predefined wavelength; and
a reflection apodization element having an intrinsic impedance that matches a characteristic impedance of free-space, the reflection apodization element mounted upon the signal reflecting surface with an inner edge of the reflection apodization element arranged in substantial contact with the signal reflecting surface at an inner portion of the signal reflecting surface, and an outer edge of the reflection apodization element elevated above a peripheral portion of the signal reflecting surface to a height corresponding to a quarter-wavelength of the predefined wavelength.

2. The radio-frequency reflector of claim 1, further comprising:
an abutment member arranged to prevent a lateral shift of the inner edge of the reflection apodization element towards a central portion of the signal reflecting surface; and
a standoff member arranged to provide support to the outer edge of the reflection apodization element, the standoff member having a height that is selected to elevate the outer edge of the reflection apodization element to the height corresponding to the quarter-wavelength of the predefined wavelength.

3. The radio-frequency reflector of claim 1, wherein the intrinsic impedance is an effective intrinsic impedance provided by a mesh structure in the reflection apodization element.

4. The radio-frequency reflector of claim 1, wherein the signal reflecting surface is a circular signal reflecting surface and the reflection apodization element is one of an array of substantially similar reflection apodization elements mounted in an annular configuration upon the circular signal reflecting surface.

5. The radio-frequency reflector of claim 1, wherein the signal reflecting surface includes one of a circular signal reflecting surface or an oval-shaped signal reflecting surface, and wherein the signal reflecting surface further includes at least one of a planar signal reflecting portion or a curved signal reflecting portion.

6. The radio-frequency reflector of claim 1, wherein the reflection apodization element when mounted upon the signal reflecting surface is configured to include at least one linearly sloping segment that bestows a substantially raised-cosine reflectance characteristic to the at least one radio-frequency signal of the predefined wavelength.

7. The radio-frequency reflector of claim 6, wherein the linearly sloping reflecting segment is arranged to provide a substantially zero reflectance to the at least one radio-frequency signal at the periphery portion of the signal reflecting surface.

8. The radio-frequency reflector of claim 1, wherein at least one reflection apodization element comprises a non-linearly sloping reflecting segment.

9. The radio-frequency reflector of claim 1, wherein the signal reflecting surface has a quadrilateral-shaped periphery.

10. A method of making a radio-frequency reflector, the method comprising:
providing a planar resistive sheet having a sheet impedance (Zₛₕₑₑₜ) that is less than a characteristic impedance (Z₀) of free-space;
transforming the planar resistive sheet into a reflection apodization element having a mesh structure, the mesh structure providing an effective intrinsic impedance equal to the characteristic impedance (Z₀) of free-space, the transforming comprising:
defining a mesh stripe width (w) to pitch (p) ratio that is substantially equal to Zₛₕₑₑₜ/Z₀; and
fabricating the mesh structure into the planar resistive sheet using the mesh stripe width (w) to pitch (p) ratio.

11. The method of claim 10, further comprising:
mounting the reflection apodization element upon a signal reflecting surface of the radio-frequency reflector with an inner edge of the reflection apodization element arranged in substantial contact with the signal reflecting surface at an inner portion of the signal reflecting surface and an outer edge of the reflection apodization element elevated above a peripheral portion of the signal reflecting surface to a height corresponding to a quarter-wavelength of a predefined wavelength.

12. The method of claim 11, wherein the sheet impedance (Zₛₕₑₑₜ) of the planar resistive sheet encompasses a range from about 10 Ω/square to about 150 Ω/square.

13. The method of claim 10, wherein the mesh stripe width (w) to pitch (p) ratio is about 0.54.

14. A method of using a radio-frequency reflector, the method comprising:
using a central portion of a signal reflecting surface of the radio-frequency reflector to provide a uniform level of reflectance to a first portion of a radio-frequency signal of a predefined wavelength; and
using a reflection apodization element of the radio-frequency reflector to provide an apodized reflectance to a second portion of the radio-frequency signal of the predefined wavelength, the apodized reflectance characterized at least in part by a substantially zero reflectance at a periphery portion of the signal reflecting surface.

15. The method of claim 14, wherein the reflection apodization element has at least one of an intrinsic impedance or an effective intrinsic impedance that is equal to a characteristic impedance (Z₀) of free-space, and wherein the apodized reflectance is provided by the reflection apodization element based on having an inner edge of the reflection apodization element arranged in substantial contact with the signal reflecting surface at an inner portion of the signal reflecting surface and an outer edge of the reflection apodization element elevated above a peripheral portion of the signal reflecting surface to a height corresponding to a quarter-wavelength of the predefined wavelength.

16. The method of claim 15, wherein the reflection apodization element comprises a mesh structure having the effective intrinsic impedance that is equal to the characteristic impedance (Z₀) of free-space.

17. The method of claim 15, wherein the signal reflecting surface is a circular signal reflecting surface and the reflection apodization element is one of an array of substantially similar reflection apodization elements mounted in an annular configuration upon the circular signal reflecting surface.

18. The method of claim 15, wherein the signal reflecting surface is one of a circular signal reflecting surface or an oval-shaped signal reflecting surface and includes at least one of a planar signal reflecting portion or a curved signal reflecting portion.

19. The method of claim 15, wherein the reflection apodization element when mounted upon the signal reflecting surface is configured to include at least one linearly sloping segment that bestows a substantially raised-cosine reflectance characteristic to the second portion of the radio-frequency signal of the predefined wavelength.

20. The method of claim 15, wherein the reflection apodization element comprises a non-linear sloping reflecting segment.
